(19) United States
(12) Patent Application Publication
(10) Pub. No.: US 2023/0039748 A1
(43) Pub. Date: Feb. 9, 2023

(54) Transmission and Drive System of a Motor Vehicle

(71) Applicant: ZF Friedrichshafen AG, Friedrichshafen (DE)

(72) Inventors: Johannes Kaltenbach, Friedrichshafen (DE); Martin Brehmer, Tettnang (DE); Matthias Horn, Tettnang (DE); Fabian Kutter, Kressbronn (DE); Stefan Beck, Eriskirch (DE)

(21) Appl. No.: 17/788,902

(22) PCT Filed: Mar. 23, 2021
(86) PCT No.: PCT/EP2021/057358

§ 371 Date: Jun. 24, 2022

(30) Foreign Application Priority Data
Apr. 22, 2020 (DE) 10 2020 205 089.9

(51) Int. Cl. B60K 6/365; B60K 6/40; B60K 6/44

(52) U.S. Cl. CPC B60K 6/365; B60K 6/40; B60K 6/44

(57) ABSTRACT

A transmission (2) of a motor vehicle includes a first sub-transmission (5) including a first input shaft (7) and a countershaft (11) coupled to the first input shaft (7) via a constant ratio (ic). The transmission (2) further includes a second sub-transmission (6) including a second input shaft (8), the second sub-transmission (6) being a planetary transmission (PG) with a sun gear (24), a ring gear (22), and a carrier (23). Moreover, the transmission (2) includes an output shaft (9), and a shift element (E). The carrier (23) is coupleable to the output shaft (9) via the shift element (E), and the ring gear (22) is the second input shaft (8) of the second sub-transmission (6).

### CROSS-REFERENCE TO RELATED APPLICATION

The present application is related and has right of priority to German Patent Application No. 10 2020 205 089.9 filed on Apr. 22, 2020 and is a nationalization of PCT/EP2021/057358 filed in the European Patent Office on Mar. 23, 2021, both of which are incorporated by reference in their entirety for all purposes.

### FIELD OF THE INVENTION

The invention relates generally to a transmission of a motor vehicle. In addition, the invention relates generally to a transmission system of a motor vehicle.

### BACKGROUND

US 2017/0129323 A1 describes a transmission of a motor vehicle, particularly a hybrid vehicle. The transmission includes a first input shaft, to which a first prime mover is coupleable, and a second input shaft, to which a second prime mover is coupleable. Moreover, the transmission includes an output shaft, to which a drive output is coupleable. The first input shaft is an integral part of a first sub-transmission for the first prime mover. The second input shaft is an integral part of a second sub-transmission for the second prime mover. Each of the sub-transmissions is a spur gear drive according to US 2017/0129323 A1. The two sub-transmissions are coupleable to one another via a shift element arranged on a countershaft.

The transmission according to US 2017/0129323 A1 needs a relatively large installation space and has a relatively high weight.

### SUMMARY OF THE INVENTION

A new type of transmission of a motor vehicle and a transmission system having the new type of transmission are disclosed herein.

The transmission includes a first input shaft for a first prime mover.

In addition, the transmission includes a second input shaft for a second prime mover.

Moreover, the transmission includes an output shaft.

The transmission has a first sub-transmission for the first prime mover. The first sub-transmission includes the first input shaft and a countershaft coupled to the first input shaft via a constant ratio.

The transmission has a second sub-transmission including the second input shaft for the second prime mover, wherein the second sub-transmission is a planetary transmission including a sun gear, a ring gear, and a carrier, wherein the ring gear forms the second input shaft of the second sub-transmission, wherein the carrier is coupled to the output shaft via a shift element.

Preferably, the planetary transmission has one single planetary gear set. This is intended primarily to clarify that the planetary transmission does not have multiple planetary gear sets.

Preferably, gearwheels are arranged on the countershaft, which engage exclusively into gearwheels arranged coaxially to the first input shaft, wherein at least some of the gearwheels arranged coaxially to the first input shaft engage into gearwheels arranged on the output shaft. Shift elements associated with the first input shaft as well as with the countershaft, depending on their engagement position for the first prime mover, provide either a gear having a first number of gearwheels meshing or a winding-path gear having a second, larger number of gearwheels meshing.

Advantageously, the sun gear is fixedly connected to the housing.

The first sub-transmission for the first prime mover is a spur gear drive having intermeshing gearwheels, where the first prime mover is preferably an internal combustion engine. Gearwheels arranged on the countershaft mesh preferably exclusively into gearwheels that are arranged coaxially to the first input shaft of the first sub-transmission. As a result, the countershaft is freely positionable in space in relation to the first input shaft. Depending on the engagement position of the shift elements associated with the first sub-transmission, namely the countershaft and the first input shaft, the first sub-transmission provides either a conventional gear with a first number, in particular with two, of gearwheels meshing or a winding-path gear with a second number, namely with four, of gearwheels meshing.

The second sub-transmission for the second prime mover is a planetary transmission, where the second prime mover is preferably an electric machine. The ring gear provides the second input shaft of the second sub-transmission. The carrier is coupled via a gearwheel to the output shaft common to both sub-transmissions. Moreover, the carrier is coupled to a gearwheel of the countershaft via a further gearwheel. This coupling is carried out via a shift element, preferably a gearshift clutch.

A particularly compact is implemented for the transmission according to the invention. This is due to, among other things, the fact that the second sub-transmission is a planetary transmission and the countershaft is freely positionable in space in relation to the first input shaft and does not mesh with the output shaft. The countershaft and the output shaft are relatively short due to the second sub-transmission being a planetary transmission. One further installation space-related advantage is implemented when the shift elements associated with the second sub-transmission are a double shift element and are located in the transmission, namely at the same end as the connection of the first prime mover.

According to one advantageous refinement, the carrier of the planetary transmission is coupled to the output shaft via a shift element and a gearwheel arranged coaxially to the first input shaft, wherein the carrier of the planetary transmission is coupled to a gearwheel arranged on the countershaft via the shift element and one further gearwheel arranged coaxially to the first input shaft. The gearwheel arranged coaxially to the first input shaft, which couples the carrier of the planetary transmission to the output shaft via a shift element, and the gearwheel arranged coaxially to the first input shaft, which couples the carrier of the planetary transmission to a gearwheel arranged on the countershaft via a shift element, are preferably idler gears of the first input shaft and are connected to each other in a rotationally fixed manner.

This embodiment is preferred in order to couple the carrier to the output shaft and to a gearwheel of the countershaft with minimal installation space. All desired gear stages are provided with minimal installation space.

According to one advantageous refinement, one further shift element is associated with the planetary transmission, via which a speed superimposition mode for the first prime mover and the second prime mover is implementable depending on the engagement position at the planetary transmission.

According to one advantageous refinement, a third prime mover is present, the third prime mover being an electric machine, wherein the third prime mover is operatively connected to the first input shaft. For the case in which a further, third prime mover is present, with the third prime mover being an electric machine, as is the case with the second prime mover, further advantages are achieved. In particular, the third prime mover as an electric machine is operable as a starter generator and improves the function of the transmission and/or of the transmission system including the transmission. For the case in which a separating clutch is additionally present between the first prime mover and the first input shaft, with the first prime mover being an internal combustion engine, purely electric powershifts are provided when the separating clutch is disengaged. As a result, the operation of a transmission system including the transmission is further improved.

Preferably, the third prime mover is coupled either to the fixed gear arranged on the first input shaft or to the fixed gear arranged on the countershaft. A separated fixed gear for the connection is then avoided.

### BRIEF DESCRIPTION OF THE DRAWINGS

Preferred refinements result from the dependent claims and the following description. Exemplary embodiments of the invention are explained in greater detail with reference to the drawing, without being limited thereto, in which:

FIG. 1 shows a diagram of a transmission system of a motor vehicle with a first exemplary embodiment of a transmission;

FIG. 2 shows a gear shift matrix of the transmission system from FIG. 1;

FIG. 3 shows a diagram of a transmission system of a motor vehicle with a second exemplary embodiment of a transmission;

FIG. 4 shows a diagram of a transmission system of a motor vehicle with a third exemplary embodiment of a transmission;

FIG. 5 shows a diagram of a transmission system of a motor vehicle with a fourth exemplary embodiment of a transmission;

FIG. 6 shows a diagram of a transmission system of a motor vehicle with a fifth exemplary embodiment of a transmission;

FIG. 7 shows a diagram of a transmission system of a motor vehicle with a sixth exemplary embodiment of a transmission;

FIG. 8 shows a diagram of a transmission system of a motor vehicle with a seventh exemplary embodiment of a transmission;

FIG. 9 shows a diagram of a transmission system of a motor vehicle with an eighth exemplary embodiment of a transmission;

FIG. 10 shows a diagram of a transmission system of a motor vehicle with a ninth exemplary embodiment of a transmission;

FIG. 11 shows a diagram of a transmission system of a motor vehicle with a tenth exemplary embodiment of a transmission;

FIG. 12 shows a diagram of a transmission system of a motor vehicle with an eleventh exemplary embodiment of a transmission; and

FIG. 13 shows a diagram of a transmission system of a motor vehicle with a twelfth exemplary embodiment of a transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

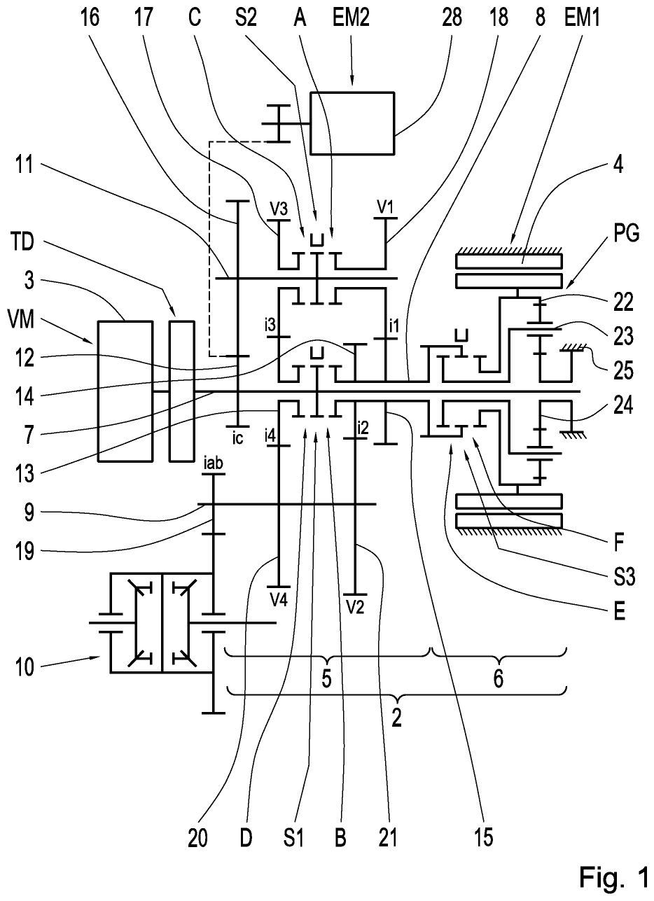

FIG. 1 shows a diagram of a transmission system 1 of a motor vehicle according to the invention, which includes a transmission 2 according to the invention.

The transmission system 1 includes, in addition to the transmission 2, a first prime mover 3 and a second prime mover 4, wherein the first prime mover 3 is preferably an internal combustion engine VM and the second prime mover 4 is preferably an electric machine EM1. Thus, the transmission system from FIG. 1 is a hybrid transmission system.

The transmission 2 includes two sub-transmissions 5, 6. The first sub-transmission 5 acts as a sub-transmission for the first prime mover 3, which is preferably the internal combustion engine VM, wherein the first prime mover 3 is coupleable to a first input shaft 7 of the first sub-transmission 5 of the transmission 2.

A damping device TD is arranged between the internal combustion engine VM and the first input shaft 7. The damping device TD includes a torsion damper and/or a damper and/or a slipping clutch, where the torsion damper is a dual-mass flywheel and the damper is a rotational speed-adaptive damper.

The second sub-transmission 6 acts as a sub-transmission for the second prime mover 4, which is the electric machine EM1, wherein the second prime mover 4, which is coupleable to a second input shaft 8 of the transmission 2 of the second sub-transmission 6.

In addition, the transmission 2 includes an output shaft 9, which is common to both sub-transmissions 5, 6 and to which a drive output 10 is coupled. A differential 10 is part of the drive output 10.

The first sub-transmission 5 includes, in addition to the first input shaft 7, a countershaft 11, to which the first prime mover 3, preferably as the internal combustion engine VM, is permanently coupled in the exemplary embodiment shown from FIG. 1. The countershaft 11 extends in parallel to the first input shaft 7, is coupled to the first input shaft 7 via a constant ratio ic, and includes gearwheels 16, 17, 18, which mesh exclusively and respectively with gearwheels 12, 13, and 15 arranged coaxially to the first input shaft 7. Thus, the countershaft 11 has no gearwheel meshing with the output shaft 9 and/or the differential 10, as the result of which the countershaft 11 is advantageously located in relation to the first input shaft 7, and, in fact, is arrangeable nearly arbitrarily freely in space, provided a geometric collision with other assemblies does not arise.

The gearwheels 12, 13, 14, 15 are positioned coaxially to the first input shaft 7. The gearwheel 12 is a fixed gear, which is coupled to the first input shaft 7 in a rotationally fixed manner. The gearwheels 13, 14, 15, however, are idler gears. The two idler gears 14, 15 are coupled to one another in a rotationally fixed manner.

Two shift elements B, D are associated with the first input shaft 7. These two shift elements B, D are preferably an engaging device S1 as a double shift element S2, wherein only one of these shift elements B, D is ever engaged at a time.

When the shift element D is engaged, the idler gear 13 is coupled to the first input shaft 7 in a rotationally fixed manner. However, when the shift element B is engaged, the two gearwheels 14, 15 coupled to one another in a rotationally fixed manner are coupled to the first input shaft 7 in a rotationally fixed manner.

As mentioned above, the countershaft 11 is engaged with the first input shaft 7 via the constant ratio ic. Particularly, the fixed gear 16 associated with the countershaft 11 meshes with the fixed gear 12 of the first input shaft 7.

In addition, the countershaft 11 supports the idler gears 17, 18, wherein the idler gear 17 of the countershaft 11 meshes with the idler gear 13 of the first input shaft 7, whereas the idler gear 18 of the countershaft 11 meshes with the idler gear 15 of the first input shaft 7.

Two shift elements A, C are associated with the countershaft 11 and are preferably made available in an engaging device S2 as a double shift element, such that only one of these shift elements A, C is ever engaged at a time.

When the shift element C is engaged, the idler gear 17 of the countershaft 11 is rotationally fixed to the countershaft 11. However, when the shift element A is engaged, the idler gear 18 of the countershaft 11 is rotationally fixed to the countershaft 11.

The gearwheels 16, 17, 18 of the countershaft 11 mesh, as mentioned above, exclusively and respectively into gearwheels 12, 13, 15 positioned coaxially to the first input shaft 7. The gearwheels 16, 17, 18 of the countershaft 11 do not mesh into gearwheels 19, 20, 21 of the output shaft 9. The gearwheels 19, 20, 21 of the output shaft 9 are all fixed gears of the output shaft 9. The gearwheel 19 meshes into the differential of the drive output 10. The gearwheel 20 meshes into the idler gear 13 of the first input shaft 7, and the gearwheel 21 meshes into the idler gear 14 of the first input shaft 7.

Accordingly, the first sub-transmission 5 for the first prime mover 3 is a spur gear drive made up of intermeshing gearwheels, where the first prime mover 3 is preferably the internal combustion engine VM. Depending on the shift position of the shift elements A, B, C, D associated with the first sub-transmission 5, either conventional gears with a first number of gearwheels meshing, namely with two gearwheels meshing, or winding-path gears with a larger, second number of gearwheels meshing, namely with four gearwheels meshing, is made available, wherein the winding-path gears with the four gearwheels meshing are the gears in which either the shift element A or the shift element C is engaged.

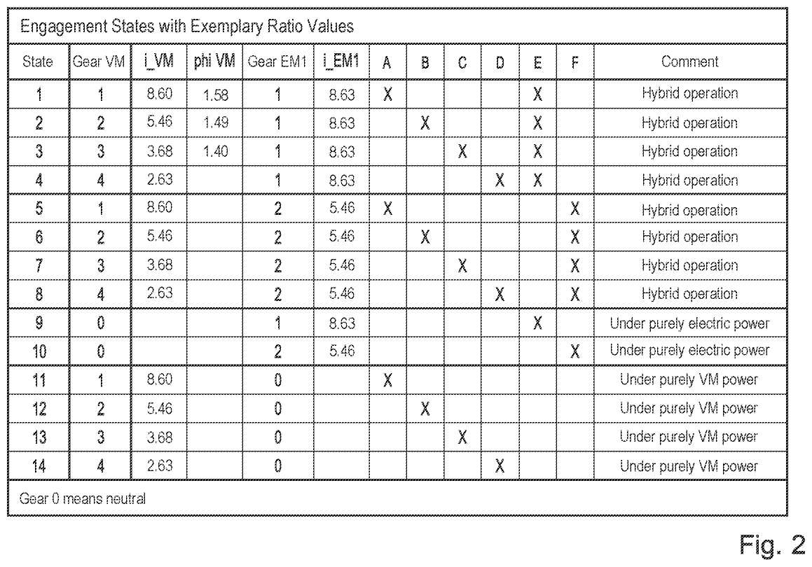

The gear shift matrix from FIG. 2 shows that the internal combustion engine gears gear VM1 and gear VM3 are these types of winding-path gears. The gears gear VM2 and gear VM4, however, are conventional gears with only two instances of gearwheel meshing.

The second sub-transmission 6 for the second prime mover 4 is a planetary transmission PG including a ring gear 22, a carrier 23, and a sun gear 24, where the second prime mover 4 is preferably an electric machine EM1.

The ring gear 22 of the planetary transmission PG provides the second input shaft 8 of the transmission 2, namely of the second sub-transmission 6. In FIG. 1, the electric machine EM1 (the second prime mover 4) is directly and/or indirectly coupled to the second input shaft 8 and positioned coaxially to the planetary transmission PG, and so the planetary transmission PG is arranged nested in the rotor of the electric machine 4.

The output side of the planetary transmission 6 is formed by the carrier 23, which is coupleable via the shift element E, on the one hand, to the output shaft 9 and, on the other hand, to a gearwheel of the countershaft 11.

FIG. 1 shows that the carrier 23 of the planetary transmission and of the second sub-transmission 6 is coupled or coupleable to the idler gear 14 and, via the idler gear 14 to the fixed gear 21 of the output shaft 9, and thus to the output shaft 9.

Moreover, when the shift element E is engaged, the carrier 23 according to FIG. 1 is rotatably coupled with the gearwheel 14 and with the gearwheel 18 of the countershaft 11 via the gearwheel 15, where each of the gearwheels 14, 15 is an idler gear of the first input shaft 7.

The idler gears 17, 18 of the countershaft 11 are coupleable to the countershaft 11 in a rotationally fixed manner depending on the engagement position of the shift elements C, A, respectively, and are thus operatively connected to the output shaft 9 via the idler gears 13, 14 of the first input shaft 7, respectively, which, depending on the engagement position of the shift elements D, B, respectively, are coupleable to the first input shaft 7 in a rotationally fixed manner. The gearwheels 16, 17, 18 of the countershaft 11 mesh exclusively into the gearwheels 12, 13, 15 positioned coaxially to the first input shaft 7, however, and not into gearwheels of the output shaft 9.

The shift elements E, F are associated with the second sub-transmission 6. Depending on the engagement position of the shift elements E, F, either the carrier 23 or the ring gear 22 is coupled to the second input shaft 8. When the shift element E is engaged, the carrier 23 is connected to the second input shaft 8. When the shift element F is engaged, in FIG. 1, the ring gear 22 is connected to the second input shaft 8.

In summary, the following is said about the embodiment according to FIG. 1:

The sun gear 24 is permanently fixed to the housing. The electric machine EM1 is connected to the ring gear 22. The shift element E connects the second input shaft 8 to the carrier 23, enabling a first electric gear E1 to be engaged. The shift element F connects the second input shaft 8 to the ring gear 22 and to the rotor of the electric machine EM1, enabling a second electric gear E2 to be engaged. The second input shaft 8 is permanently connected to the drive output via the spur gear stage i2, which represents the gear V2. This represents the sub-transmission 6 for the electric machine EM1. The shift elements E/F are combinable as a double shift element or engaging device S3. This has the advantage that, when both shift elements E, F are disengaged, both the electric machine EM1 and the planetary transmission PG are decoupled and cause no drag losses during the driving operation under purely internal combustion engine power (states 11-14). “Under purely internal combustion engine power” means that the large electric machine EM1 is decoupled, but the smaller electric machine EM2 rotates, provided it is present.

The sub-transmission 5 for the internal combustion engine VM is preferably as follows:
from the input shaft 7, two gears V2, V4 are engaged directly onto the output shaft 9. This takes place via 2 meshing points and via either of the shift elements B, D.
the countershaft 11 is driven with a constant ratio ic.
there are two so-called winding-path gears, each of which is engaged with one of the shift elements A, C. The power flow is guided, in each case, to the output shaft 9 with a diversion via the countershaft 11. There are 4 meshing points in each case.
a plurality of engagement states is possible including operation under purely electric power, operation under purely internal combustion engine power, and hybrid operation.
the two electric gears E1, E2 are not power shiftable with one another.
in the hybrid mode, powershifts are possible due to electrical tractive force support with the electric machine EM1.

Some advantages as compared to the prior art relate to the installation space:
the countershaft 11 is freely pivotable in space since it does not intermesh with the differential.
the countershaft 11 is shorter.
the spur gear stage iab and the spur gear stage ic lie in one shared axial plane (reducing axial installation space).

The transmission 2 is utilized for a driving operation under purely electric power, a driving operation under purely internal combustion engine power, and a hybrid operation. The gear shift matrix from FIG. 2 summarizes, with the states 1 through 14, the particular possible driving operations, gears, and exemplary gear stages of the transmission in the particular gears. Shift elements that are engaged in the particular gear and/or state of the transmission 2 are marked with an X in the gear shift matrix from FIG. 2.

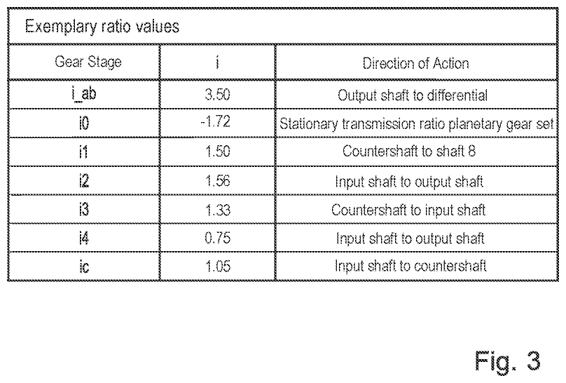

The ratio values in the gear shift matrix from FIG. 3 are merely examples. The gear stages are represented in FIG. 1.

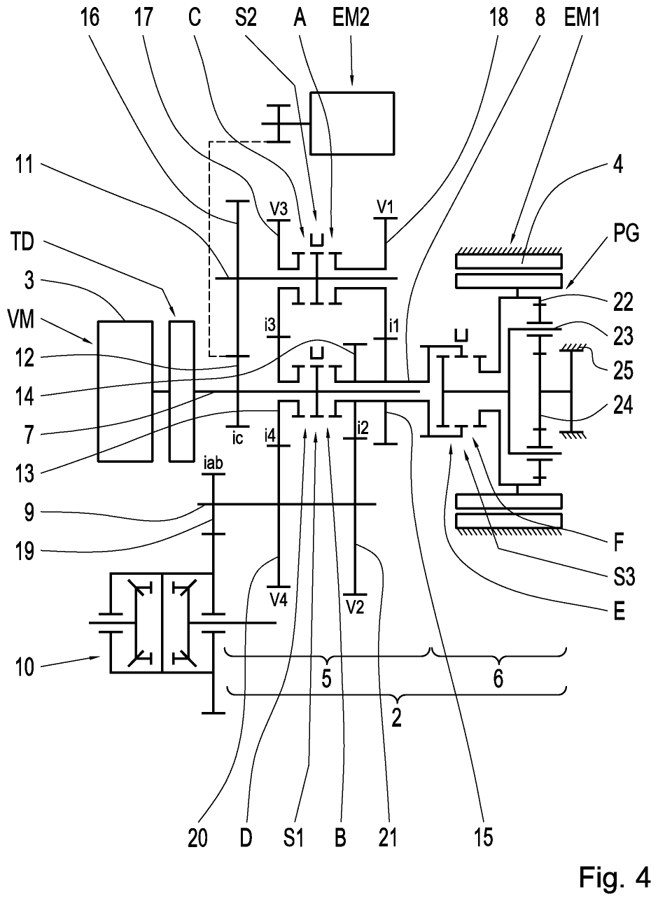

FIG. 4 shows a modification of the exemplary embodiment from FIG. 1, in which the input shaft 7 does not extend to the end of the transmission. The advantages and disadvantages are of a structural nature. The gear shift matrix is the same as represented with respect to FIG. 1, i.e., the gear shift matrix shown in FIG. 2.

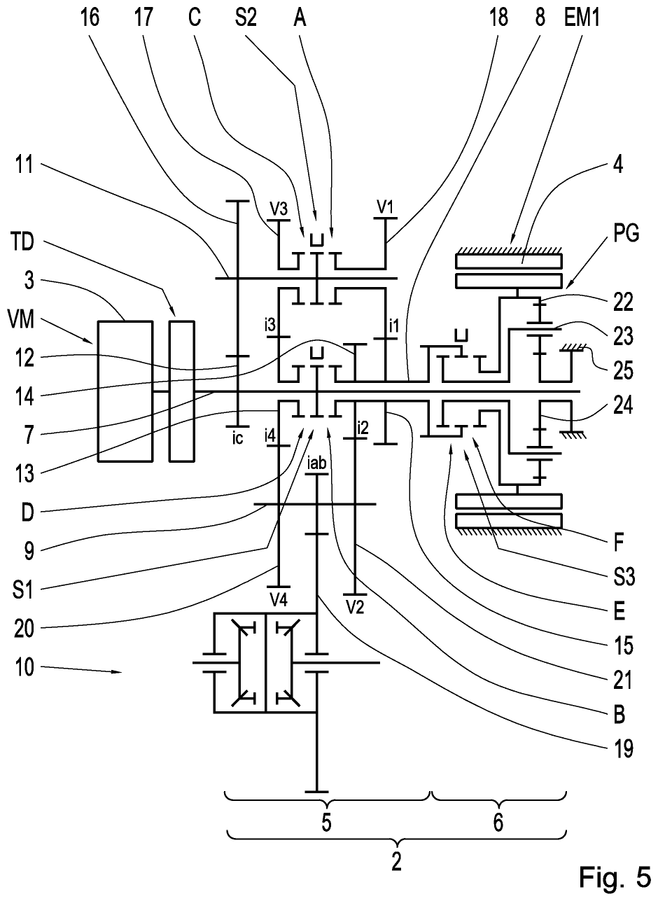

FIG. 5 shows a modification of the exemplary embodiment from FIG. 1, in which the drive output 9 to the differential is arranged between the two stages i2, i4. The advantages and disadvantages are of a structural nature. The gear shift matrix is the same as represented with respect to FIG. 1, i.e., the gear shift matrix shown in FIG. 2. This modification is also possible in the embodiment according to FIG. 4. The electric machine EM2 is not represented, although it is optionally, advantageously present.

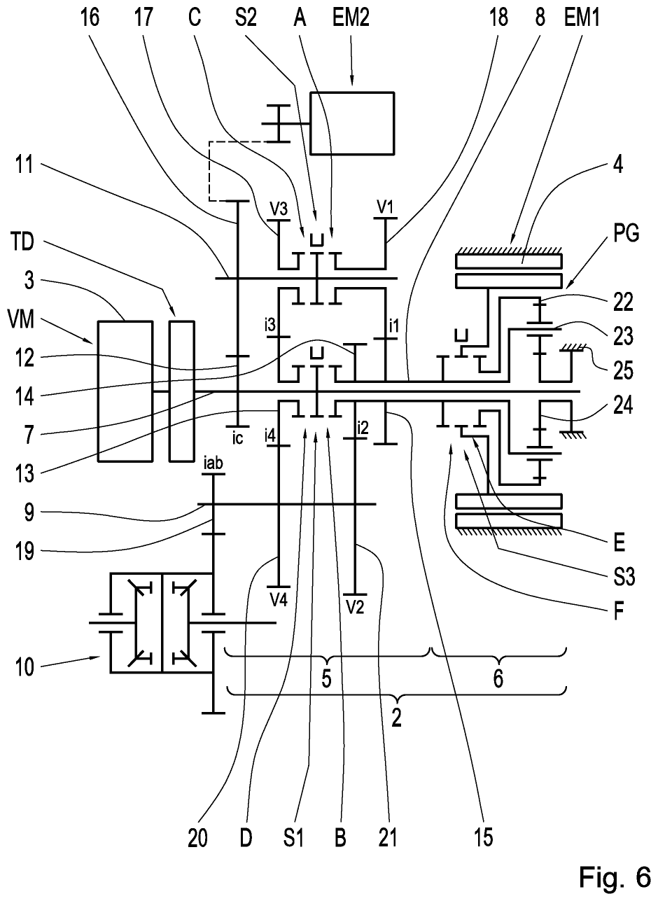

FIG. 6 shows one further modification of the exemplary embodiment from FIG. 1, in which the rotor of the electric machine EM1 is not permanently connected to the ring gear, but rather is switched between being connected to the ring gear 22 or the carrier 23 with the double shift element E/F. The carrier 23 is permanently connected to the input shaft 8. One disadvantage is that the planetary transmission PG is not decouplable.

The gear shift matrix is the same as that represented with respect to FIG. 1, i.e., the gear shift matrix shown in FIG. 2.

According to one further modification (not represented), the electric machine EM2 is connected to the countershaft 11, for example, via an intermediate gear. The modification is functionally equivalent to the embodiment according to FIG. 1 since the countershaft 11 is permanently operatively connected to the internal combustion engine VM.

This modification is implementable in all described embodiments.

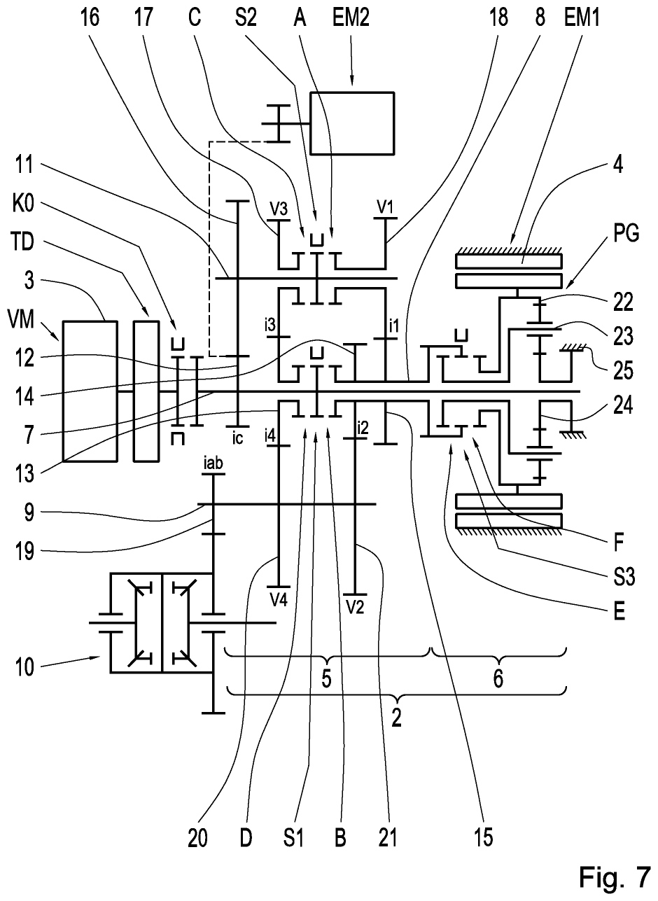

FIG. 7 shows one further modification of the exemplary embodiment from FIG. 1, in which a separating clutch K0 for the internal combustion engine VM has been included. The separating clutch K0 is a dog clutch or, alternatively, a friction clutch. The provision of the separating clutch K0 has the following advantages:
with the separating clutch K0 disengaged, a purely electric driving operation with the electric machine EM2 is possible (use of the gears V1, V2, V3, V4).
with the separating clutch K0 disengaged, a driving operation under purely electric power with the electric machines EM1, EM2 together is possible, wherein the particular gears are combined in any way.
in the driving operation under purely electric power (the separating clutch K0 disengaged), the electric machine EM2 assists the tractive force while the electric machine EM1 changes the gear.
in the driving operation under purely electric power (the separating clutch K0 disengaged), the electric machine EM1 assists the tractive force while the electric machine EM2 changes the gear.

If the separating clutch K0 is a friction clutch, further advantages result:
the separating clutch K0 is also disengageable under load, for example, during a full application of the brakes or a malfunction of the internal combustion engine VM.
the separating clutch K0 is also engageable under differential speed, and so a so-called “flywheel start” of the internal combustion engine VM with the electric machine EM2 is possible (utilization of the inertial mass of the electric machine EM2 to start the internal combustion engine VM).

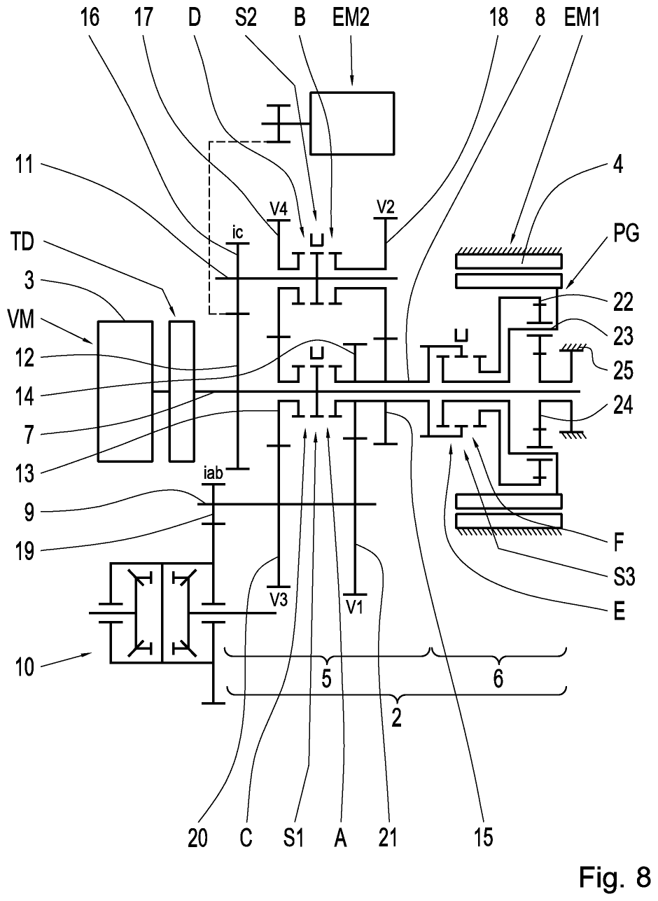

FIG. 8 shows one further modification of the exemplary embodiment from FIG. 1, in which
the planetary transmission PG is interconnected differently, with the electric machine EM1 being connected to the carrier 23.
in the engagement position F, the planetary transmission PG has a speed-increasing ratio.
the spur gear transmission ratios are therefore adapted.
the second input shaft 8 is connected to the spur gear stage of the gear V1 (in FIG. 1, the second input shaft 8 was connected to the spur gear stage of the gear V2), and so the electric machine EM1 has sufficiently high ratios toward the drive output.
the internal combustion engine VM gears without a winding path are now V1, V3 (in FIG. 1, the internal combustion engine VM gears without a winding path were V2, V4).
the winding-path gears are now V2, V4 (in FIG. 1, the winding-path gears were V1, V3).

This yields the following advantages:
in the main electric driving gear E1 (shift element E engaged), the efficiency is good (no power in the rolling planetary transmission).
the gearwheel 12 of the stage is on the input shaft 7 is larger such that the electric machine EM2 is better connected there.

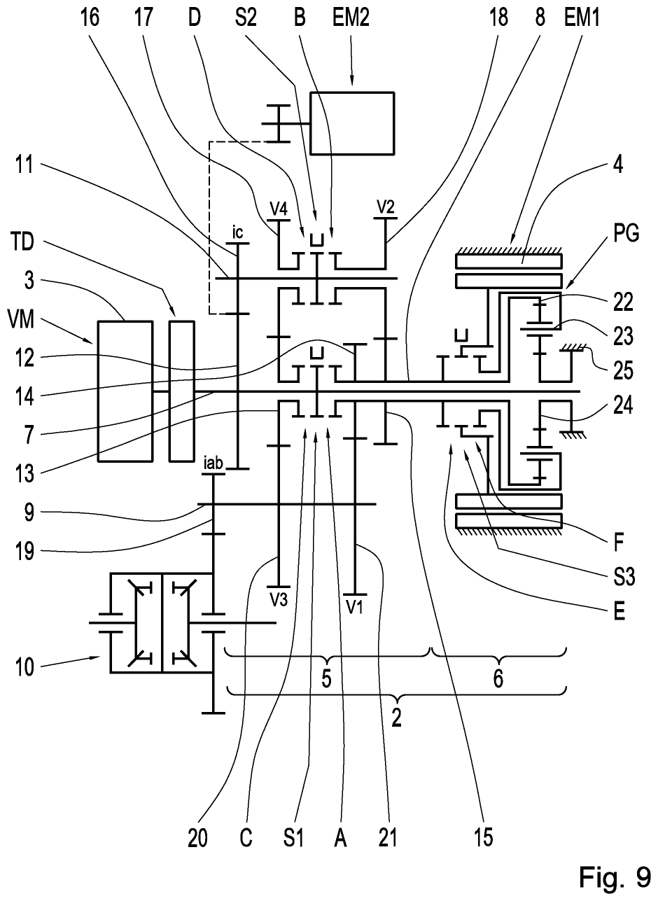

FIG. 9 shows a modification of the exemplary embodiment from FIG. 6, in which
the planetary transmission PG is interconnected differently.
in the engagement position F, the planetary transmission PG has a speed-increasing ratio.
the spur gear transmission ratios are therefore adapted.
the input shaft 8 is connected to the spur gear stage of the gear V1 (in FIG. 1, the input shaft 8 was connected to the spur gear stage of the gear V2), and so the electric machine EM1 has sufficiently high ratios toward the drive output.
the internal combustion engine VM gears without a winding path are now V1, V3 (in FIG. 1, the internal combustion engine VM gears without a winding path were V2 and V4).
the winding-path gears are now V2, V4 (in FIG. 1, the winding-path gears were V1, V3).

This yields the following advantages:
in the main electric driving gear E1 (shift element E engaged), the efficiency is good (no power in the rolling planetary transmission PG).
the gearwheel 12 of the stage is on the input shaft 7 is larger such that the electric machine EM2 is better connected there.

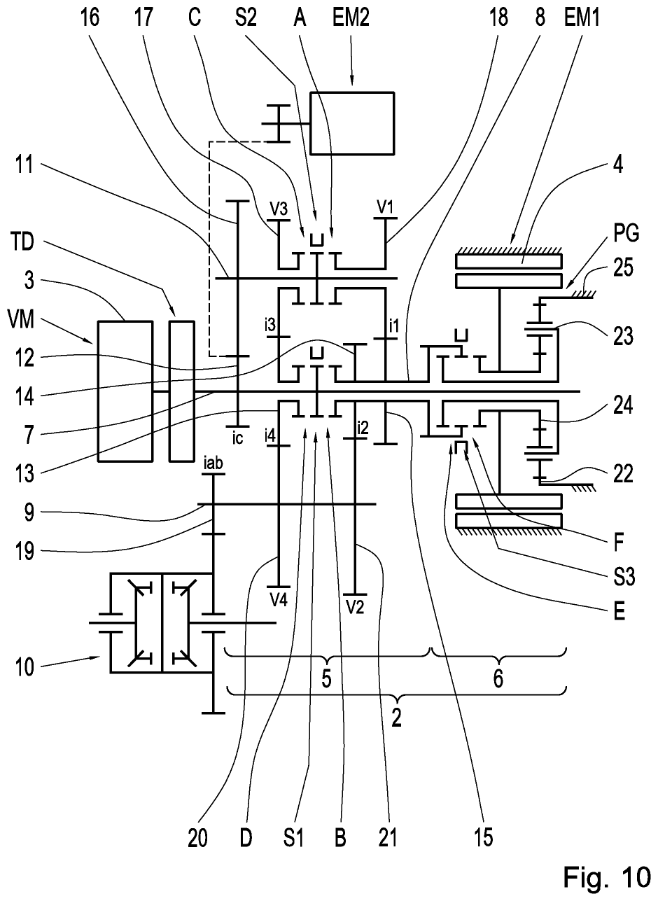

FIG. 10 shows one further modification of the exemplary embodiment from FIG. 1, in which:
the planetary transmission PG is connected differently, with the connection of the ring gear 22 and the sun gear 24 being interchanged. The ring gear 22 is permanently fixed to the housing. The sun gear 24 is connected to the rotor of the electric machine EM1.
as a result, the electric machine EM1 in the gear E1 has a considerably higher ratio than is the case with respect to FIG. 1 (for example, the ratio is 14.85 for FIG. 10 and 8.63 for FIG. 1).
the advantage is that the electric machine EM1 has a lower torque demand.
the gear E2 has the same ratio as is the case with respect to FIG. 1 (for example, the ratio is 5.46 for FIG. 10 as well as in FIG. 1).
the ratios for VM (and, if necessary, EM2) are unaffected thereby.

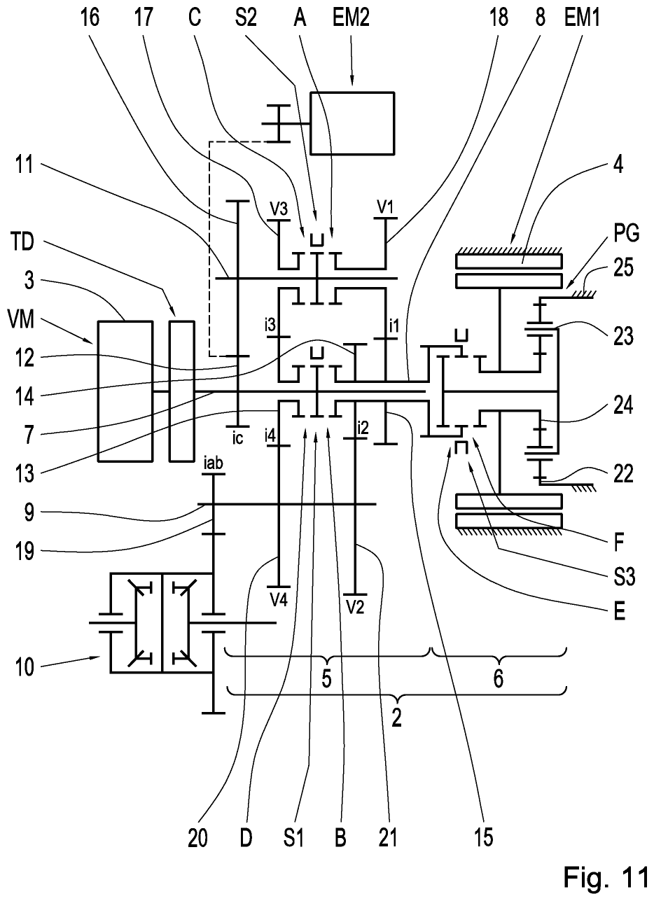

FIG. 11 shows a modification of the exemplary embodiment from FIG. 10, in which the input shaft 7 does not extend to the end of the transmission 2. The advantages and disadvantages are of a structural nature.

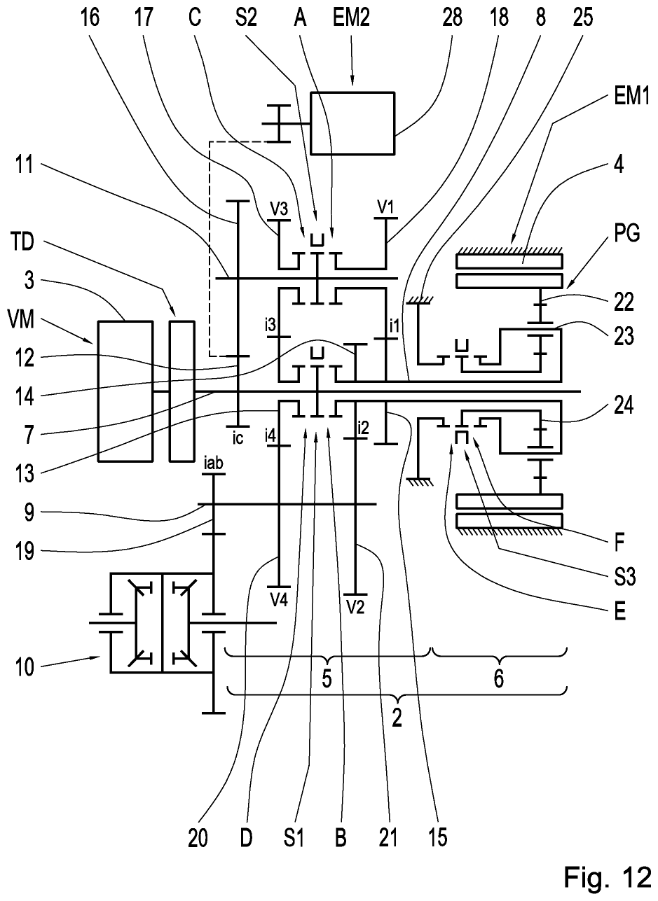

FIG. 12 shows one further modification of the exemplary embodiment from FIG. 1, in which:
the sun gear 24 for the gear E1 is engageable so as to be fixed to the housing via shift element E.
for the gear E2, the planetary transmission PG is interlocked, in that two of the three elements are connectable to each other via shift element F.
it is advantageous when the shift elements E, F are part of a double shift element. Since the sun gear 24 is engageable against the housing 25, two reasonable variants remain for the interlock with the shift element F: 1) the sun gear 24 with the ring gear 22, or 2) the sun gear 24 with the carrier 23.
the connection of the ring gear 22 to the carrier 23 would also be possible (although the double shift element would not be possible).

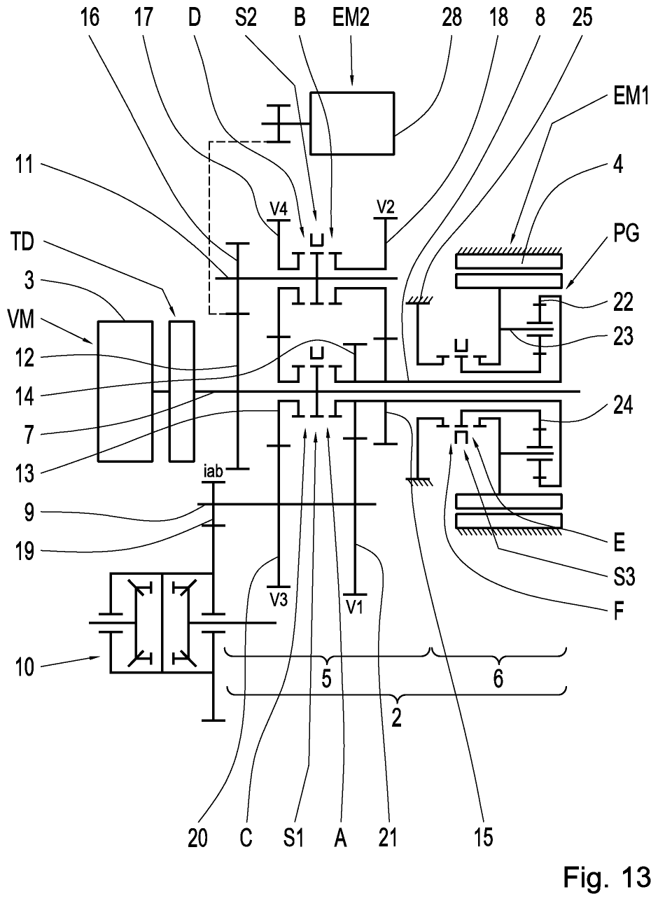

FIG. 13 shows a modification of the exemplary embodiment from FIG. 12, in which:
the planetary transmission PG is interconnected differently, with the electric machine EM1 being connected to the carrier 23.
in the engagement position F, the planetary transmission PG has a speed-increasing ratio.
the spur gear transmission ratios are therefore adapted.
the second input shaft 8 is connected to the spur gear stage of the gear V1 (in FIG. 12, the second input shaft 8 was connected to the spur gear stage of the gear V2), and so the electric machine EM1 has sufficiently high ratios toward the drive output.
the internal combustion engine VM gears without a winding path are now V1, V3 (in FIG. 12, the internal combustion engine VM gears without a winding path were V2, V4).
the winding-path gears are now V2, V4 (in FIG. 12, the winding-path gears were V1, V3).

Advantages:
in the main electric driving gear E1 (with the shift element E engaged), the efficiency is good (no power in the rolling planetary transmission).
the gearwheel of the stage is on the input shaft 1 is larger such that the electric machine EM2 is better connected there.

All embodiments have the following features:

The electric machine EM1 is mountable in its entirety at the end of the transmission. An actuator for actuating the engaging device S3 having the shift elements E/F reaches the engaging device S3 from the outside on the transmission side. This is particularly useful, in the case of a particularly large and powerful electric machine EM1, when the engaging device S3 having the shift elements E/F as well as the planetary transmission PG are at least partially radially nestable within the rotor of the electric machine EM1. This has the advantage that axial installation space is saved.

The input shaft 7 does not need to extend to the end of the transmission 2. The input shaft 7 can end at the shift element B or at the spur gear stage i1. It is structurally useful, however, for mounting-related reasons, to lengthen the input shaft 7 as indicated in some figures.

It is advantageous to provide an additional starter generator (e.g., the electric machine EM2) fixedly connected to the internal combustion engine VM, since charging at a standstill is not possible with the electric machine EM1.

The electric machine EM2 is preferably connected with an intermediate gear to the stage ic.

Alternatively, the electric machine EM2 is connected, as a coaxial electric machine, to the input shaft 7.

Alternatively, the electric machine EM2 is mounted at the belt drive of the internal combustion engine VM.

The following functions are covered with the electric machine EM2, provided that the electric machine EM2 is present:
internal combustion engine start during purely electric driving.
supply of the vehicle electrical system.
serial creeping and serial driving forward/backwards, where the electric machine EM2 generates current for the electric machine EM1 in the engagement states 9, 10.
support of the closed-loop control of the rotational speed of the internal combustion engine during coupling and during gear shifts.
synchronization of constant-mesh shift elements, for example, during gear shifts, is advantageously carried out by closed-loop control of the rotational speed at an electric machine.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 transmission system
2 transmission
3 first prime mover/internal combustion engine
4 second prime mover/electric machine
5 first sub-transmission
6 second sub-transmission
7 first input shaft
8 second input shaft
9 output shaft
10 drive output
11 countershaft
12 fixed gear
13 idler gear
14 idler gear
15 idler gear
16 fixed gear
17 idler gear
18 idler gear
19 fixed gear
20 fixed gear
21 fixed gear
22 ring gear
23 carrier
24 sun gear
25 housing
28 third prime mover/electric machine
29 spur gear stage
A shift element
B shift element
C shift element
D shift element
E shift element
F shift element
K0 separating clutch
S1 engaging device
S2 engaging device
S3 engaging device

1-10. (canceled)

11. A transmission (2) of a motor vehicle, comprising:
a first sub-transmission (5) including a first input shaft (7) and a countershaft (11) coupled to the first input shaft (7) via a constant ratio (ic);
a second sub-transmission (6) including a second input shaft (8), the second sub-transmission (6) being a planetary transmission (PG) with a sun gear (24), a ring gear (22), and a carrier (23);
an output shaft (9); and
a shift element (E), wherein the carrier (23) is coupleable to the output shaft (9) via the shift element (E),
wherein the ring gear (22) is the second input shaft (8) of the second sub-transmission (6).

12. The transmission of claim 11, further comprising:
a first gearwheel (14) coaxial to the first input shaft (7);
a second gearwheel (18) on the countershaft (11); and
a further gearwheel (15) coaxial to the first input shaft (7),
wherein the carrier (23) of the planetary transmission (PG) is coupleable to the output shaft (9) by the shift element (E) and the first gearwheel (14), and
wherein the carrier (23) of the planetary transmission (PG) is coupleable to the second gearwheel (18) by the shift element (E) and the further gearwheel (15).

13. The transmission of claim 12, wherein each of the first gearwheel (14) and the further gearwheel (15) is an idler gear of the first input shaft (7), the first gearwheel (14) and the further gearwheel (15) being connected to each other in a rotationally fixed manner.

14. The transmission of claim 12, further comprising at least one shift element (A) associated with the countershaft (11),
wherein the second gearwheel (18) is an idler gear of the countershaft (11), the second gearwheel (18) being coupled to the countershaft (11) in a rotationally fixed manner when one of the at least one shift element (A) associated with the countershaft (11) is engaged.

15. The transmission of claim 11, wherein a second prime mover (4) is directly coupleable to the second input shaft (8) of the second sub-transmission (6) such that the second prime mover (4) is directly operatively connected to the second input shaft (8) of the second sub-transmission (6).

16. The transmission of claim 11, wherein a second prime mover (4) is indirectly coupleable to the second input shaft (8) of the second sub-transmission (6) such that the second prime mover (4) is indirectly operatively connected to the second input shaft (8) of the second sub-transmission (6).

17. The transmission of claim 11, wherein an electric machine (EM2) is operatively connected to the first input shaft (7).

18. The transmission of claim 11, further comprising:
a fixed gear (12) on the first input shaft (7); and
a fixed gear (16) on the countershaft,
wherein the fixed gear (12) on the first input shaft (7) meshes into the fixed gear (16) on the countershaft (11) to provide the constant ratio (ic) between the first input shaft (7) and the countershaft (11).

19. The transmission of claim 11, further comprising a separating clutch (K0) associated with the first input shaft (7) for selectively decoupling a first prime mover (3) from the first input shaft (7).

20. A transmission system (1) of a motor vehicle, comprising:
the transmission (2) of claim 11;
a first prime mover (3) coupled or coupleable to the first input shaft (7);
a second prime mover (4) coupled or coupleable to the second input shaft (8); and
a drive output (10) coupled to the output shaft (9).
